(19) United States
(12) Patent Application Publication
(10) Pub. No.: US 2020/0180892 A1
(43) Pub. Date: Jun. 11, 2020

(54) RECORDING-MEDIUM TRANSPORT DEVICE AND IMAGE FORMING APPARATUS

(71) Applicant: FUJI XEROX CO., LTD., Tokyo (JP)

(72) Inventors: Daisuke KUWABARA, Kanagawa (JP); Yoshinori SHUIN, Kanagawa (JP); Kiminobu TSUTADA, Kanagawa (JP)

(73) Assignee: FUJI XEROX CO., LTD., Tokyo (JP)

(21) Appl. No.: 16/402,218

(22) Filed: May 2, 2019

(30) Foreign Application Priority Data
Dec. 11, 2018 (JP) 2018-231491

(51) Int. Cl. B65H 29/60; B65H 29/52; B65H 5/06; G03G 15/00

(52) U.S. Cl. CPC B65H 29/60; B65H 29/52; G03G 2215/00586; G03G 15/6573; G03G 15/6579; B65H 5/06

(57) ABSTRACT

A recording-medium transport device includes: a driving roller that rotates in a driving manner; a discharge-side driven roller that is externally in contact with the driving roller and guides a recording medium to a discharge path located downstream of the driving roller in cooperation with the driving roller; a duplex-path-side driven roller that is externally in contact with the driving roller and guides, in cooperation with the driving roller, the recording medium from the discharge path to a duplex printing path; and a projection projecting further toward the discharge path than an outer circumferential surface of the driving roller.

### CROSS-REFERENCE TO RELATED APPLICATIONS

This application is based on and claims priority under 35 USC 119 from Japanese Patent Application No. 2018-231491 filed Dec. 11, 2018.

### BACKGROUND

### (i) Technical Field

The present disclosure relates to a recording-medium transport device and an image forming apparatus.

### (ii) Related Art

Image forming apparatuses have a recording-medium transport device that transports a recording medium, such as a sheet.

Japanese Patent No. 3889245 discloses a recording-medium transport device that includes: a discharging roller fixed to a rotation shaft and a drawing prevention member attached to the rotation shaft. The drawing prevention member prevents a recording medium from being drawn into the gap between the discharging roller and a housing of an image forming apparatus.

Japanese Unexamined Patent Application Publication No. 2003-276921 discloses a recording-medium transport device including: a sheet-output roller; a sheet-output guide, which is a flat slope surface projecting on the front side of an image forming apparatus; and drawing prevention members for preventing a rolled sheet from being drawn into the boundary between the sheet-output guide and the legs of the image forming apparatus.

### SUMMARY

Some known image forming apparatuses can perform duplex printing. Recording-medium transport devices provided in such image forming apparatuses sometimes include: a driving roller that rotates in a driving manner to discharge a recording medium to a discharge path; and a driven roller that is externally in contact with the driving roller and thus is rotated by the driving roller, to guide the recording medium from the discharge path to a duplex printing path in cooperation with the driving roller.

In such recording-medium transport devices, a recording medium that should be transported along the discharge path and discharged from the discharge port is sometimes drawn into the duplex printing path by the driving roller and the driven roller. For example, when a transported recording medium is jammed as a result of being caught by the housing (in particular, a member defining the discharge path) of the image forming apparatus or being blocked by an object disposed at the discharge port, the recording medium may be drawn into the duplex printing path. This inevitably causes abnormal discharging of the recording medium.

Aspects of non-limiting embodiments of the present disclosure relate to suppressing, in a recording-medium transport device including a driving roller and a driven roller that guides a recording medium from a discharge path to a duplex printing path in cooperation with the driving roller, drawing of the recording medium into the duplex printing path, compared with a case where projections extending toward the discharge path are not provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a recording-medium transport device including: a driving roller that rotates in a driving manner; a discharge-side driven roller that is externally in contact with the driving roller and guides a recording medium to a discharge path located downstream of the driving roller in cooperation with the driving roller; a duplex-path-side driven roller that is externally in contact with the driving roller and guides, in cooperation with the driving roller, the recording medium from the discharge path to a duplex printing path; and a projection that projects further toward the discharge path than an outer circumferential surface of the driving roller.

### BRIEF DESCRIPTION OF THE DRAWINGS

Exemplary embodiment of the present disclosure will be described in detail based on the following figures, wherein:

FIG. 1 is a schematic side view showing the structure of an image forming apparatus according to an exemplary embodiment of this disclosure;

FIG. 2 is a perspective view, as viewed from the discharge path side, showing a driving roller, a discharge-side driven roller, and a duplex-path-side driven roller;

FIG. 3 is a perspective view of a projecting member;

FIG. 4 is an enlarged side view of the driving roller and the projecting member attached to a shaft; and

FIG. 5 is an enlarged perspective view, as viewed from the discharge path side, showing the driving roller and the projecting members attached to the shaft.

### DETAILED DESCRIPTION

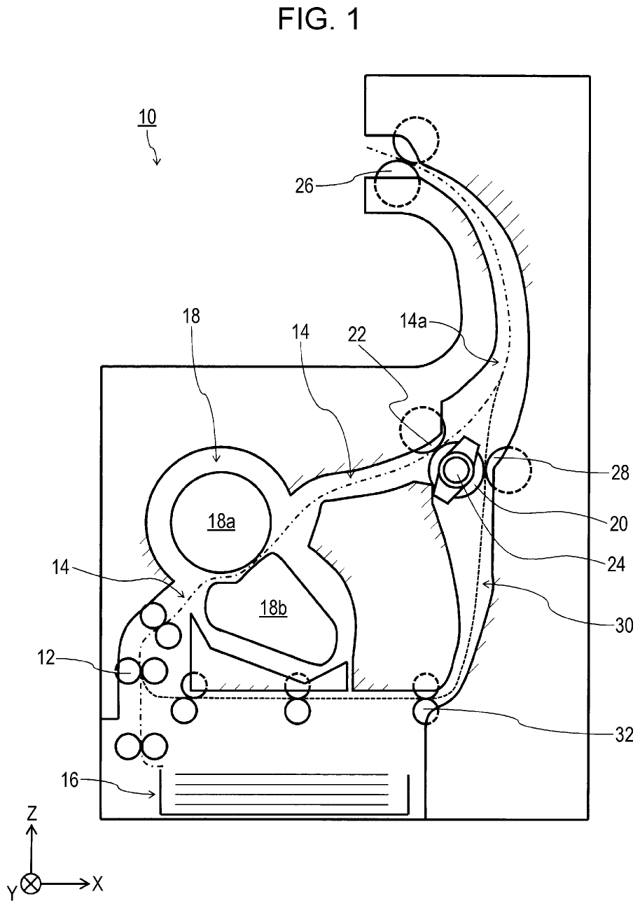

FIG. 1 is a schematic side view showing the structure of an image forming apparatus 10 according to this exemplary embodiment. The image forming apparatus 10 is a relatively small duplex printer, which can perform printing on both sides of a recording medium. Although the recording medium in this exemplary embodiment is a sheet, the recording medium is not limited thereto.

In FIGS. 1, 2, 4, and 5, the depth direction, the width direction, and the height direction of the image forming apparatus 10 correspond to the X-axis direction, the Y-axis direction, and the Z-axis direction, respectively.

One or more transport rollers 12 transport a sheet from a sheet tray 16 to an image forming part 18 along a transport path 14. FIG. 1 shows, in a one-dot chain line, an example sheet transport track along the transport path 14.

The image forming part 18 includes a photoconductor unit 18a and a developing unit 18b. The photoconductor unit 18a includes a photoconductor drum, a charging roller for charging the photoconductor drum, a cleaning blade for removing residual toner on the photoconductor drum, etc. The developing unit 18b includes a toner reservoir that stores toner, a developing roller that allows the toner to adhere to an image on the photoconductor drum, a waste toner reservoir that stores the toner removed by the cleaning blade, etc.

The photoconductor drum charged by the charging roller is exposed to a laser beam radiated from a laser light source (not shown). Then, the developing roller allows the toner to adhere to the exposed photoconductor drum, and the toner on the photoconductor drum is then transferred to the sheet. Finally, pressure and heat are applied to the sheet having the toner transferred thereto to fix the image to the sheet. The image forming part 18 forms an image on the sheet in this way.

The sheet having an image formed thereon is transported downstream of the image forming part 18, along the transport path 14.

Driving rollers 20 and discharge-side driven rollers 22 are located downstream of the image forming part 18 in the transport path 14. The driving rollers 20 are coaxially attached to a shaft 24 rotated by a motor (not shown). Hence, the driving rollers 20 rotate in a driving manner.

The discharge-side driven rollers 22 are externally in contact with the driving rollers 20. Hence, the discharge-side driven rollers 22 rotate in a driven manner with the rotation of the driving rollers 20.

The driving rollers 20 and the discharge-side driven rollers 22 together guide, to the downstream side thereof, the sheet transported from the image forming part 18 along the transport path 14. More specifically, the sheet is guided to the downstream side when the driving rollers 20 rotate in a driving manner with the sheet being nipped at the nip portions between the driving rollers 20 and the discharge-side driven rollers 22. In this disclosure, the space extending from the downstream side of the driving rollers 20 and the discharge-side driven rollers 22 to the sheet discharge port is referred to as a discharge path 14a.

A discharging roller 26 is provided at the downstream part of the discharge path 14a, near the sheet discharge port. At the end of one-side print processing or duplex print processing, the discharging roller 26 rotates forward to discharge the sheet to the outside of the image forming apparatus 10 from the discharge port. When printing on one side (i.e., the front side) is completed in duplex print processing, the discharging roller 26 rotates reversely to prevent the sheet from being discharged from the discharge port and to direct the sheet in the reverse direction (i.e., toward the driving rollers 20) along the discharge path 14a.

Duplex-path driven rollers 28 are externally in contact with the driving rollers 20 at positions where they do not interfere with the sheet guided to the discharge path 14a by the cooperation between the driving rollers 20 and the discharge-side driven rollers 22. Similarly to the discharge-side driven rollers 22, the duplex-path-side driven rollers 28 rotate in a driven manner with the rotation of the driving rollers 20.

The sheet transported back along the discharge path 14a by the cooperation between the driving rollers 20 and the duplex-path-side driven rollers 28 is guided from the discharge path 14a to the duplex printing path 30. More specifically, when the driving rollers 20 rotate in a driving manner with the sheet nipped between the driving rollers 20 and the duplex-path-side driven rollers 28, the sheet is guided to the duplex printing path 30. The sheet guided to the duplex printing path 30 is transported along the duplex printing path 30 by duplex printing rollers 32. FIG. 1 shows, in a dashed line, an example sheet transport track in printing on a second surface (i.e., the back surface).

The duplex printing path 30 joins the transport path 14 on the upstream of the image forming part 18. The sheet transported along the duplex printing path 30 passes through the transport path 14 and is transported again to the image forming part 18, where printing on the second surface is performed. The sheet having gone through duplex printing is guided again to the discharge path 14a by the cooperation between the driving rollers 20 and the discharge-side driven rollers 22 and is discharged from the discharge port by the discharging roller 26.

The recording-medium transport device according to this exemplary embodiment includes, among the components described above, the components related to the transportation of sheets, which are, for example, the transport roller 12, the transport path 14, the driving rollers 20, the discharge-side driven rollers 22, the shaft 24, the discharging roller 26, the duplex-path-side driven rollers 28, the duplex printing path 30, the duplex printing rollers 32, and projecting members described below.

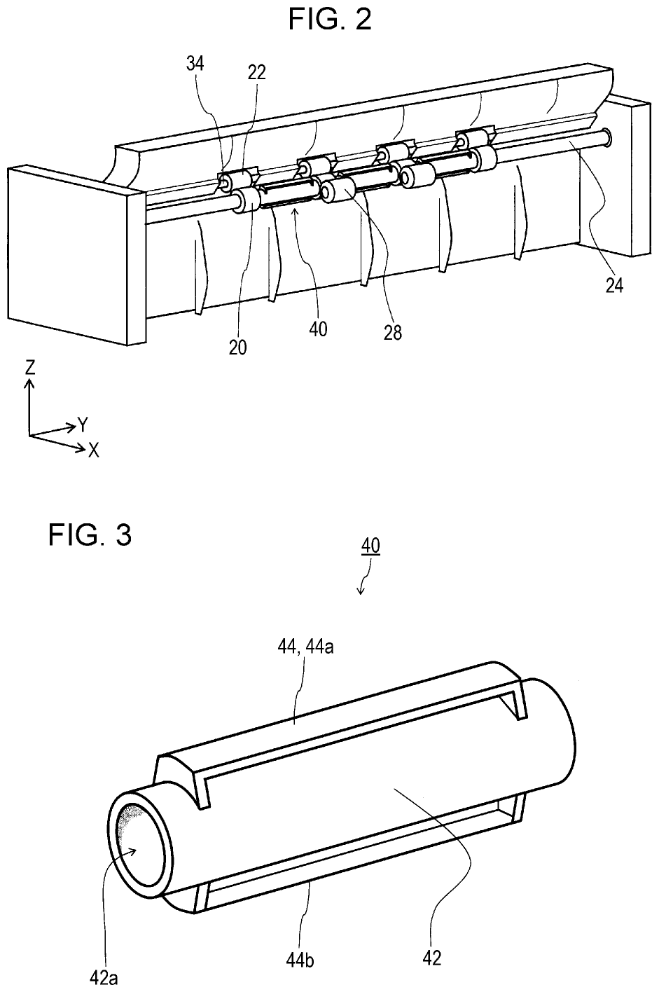

FIG. 2 is a perspective view, as viewed from the discharge path side, showing the driving rollers 20, the discharge-side driven rollers 22, and the duplex-path-side driven rollers 28. In FIG. 2, illustration of some of the components is omitted.

The shaft 24 is a cylindrical member extending in the Y-axis direction (i.e., the width direction of the image forming apparatus 10), which is perpendicular to the sheet transport direction. Multiple driving rollers 20 are attached to the shaft 24 so as to be side-by-side in the Y-axis direction. As shown in FIG. 2, in this exemplary embodiment, four driving rollers 20 are attached to the shaft 24.

The discharge-side driven rollers 22 are attached to the shaft 34 extending in the Y-axis direction so as to be side-by-side in the Y-axis direction and so as to correspond to the driving rollers 20 (that is, so as to be externally in contact with the driving rollers 20). In this exemplary embodiment, four discharge-side driven rollers 22 are provided corresponding to the four driving rollers 20.

The duplex-path-side driven rollers 28 are also attached to a shaft (not shown) extending in the Y-axis direction. Although the same number of the duplex-path-side driven rollers 28 as the driving rollers 20 may be provided so as to correspond to the driving rollers 20, the number of the duplex-path-side driven rollers 28 in this exemplary embodiment is smaller than the number of the driving rollers 20 to prevent the sheet from being drawn into the duplex printing path 30 as much as possible when the sheet is discharged from the discharge port. Even in such a configuration, it is possible to guide the sheet to the duplex printing path 30. In this exemplary embodiment, the number of the discharge-side driven rollers 22 is two, whereas the number of the driving rollers 20 is four.

The two duplex-path-side driven rollers 28 are externally in contact with the two driving rollers 20 that are located at the center in the width direction of the image forming apparatus 10, among the four driving rollers 20. During printing, sheets of various sizes are transported such that their center is aligned with the center of the image forming apparatus 10 in the width direction. Hence, by providing the duplex-path-side driven rollers 28 so as to correspond to the driving rollers 20 located at the center, duplex printing on sheets of various sizes is enabled.

Besides the driving rollers 20, projecting members 40 are coaxially attached to the shaft 24.

FIG. 3 is a perspective view of a projecting member 40. The projecting member 40 includes a cylindrical base 42 and projections 44 projecting radially outward from the outer circumferential surface of the base 42. In this exemplary embodiment, the projecting member 40 includes projections 44a and 44b projecting in the opposite directions and having the same shape as viewed in the axial direction. By inserting the shaft 24 through a through-hole 42a in the base 42, the projecting member 40 is coaxially attached to the shaft 24. The inside diameter of the through-hole 42a is slightly larger than the outside diameter of the shaft 24. When the projecting member 40 is not fixed, the projecting member 40 rotates with the shaft 24, and when the projecting member 40 is fixed, only the shaft 24 rotates inside the through-hole 42a.

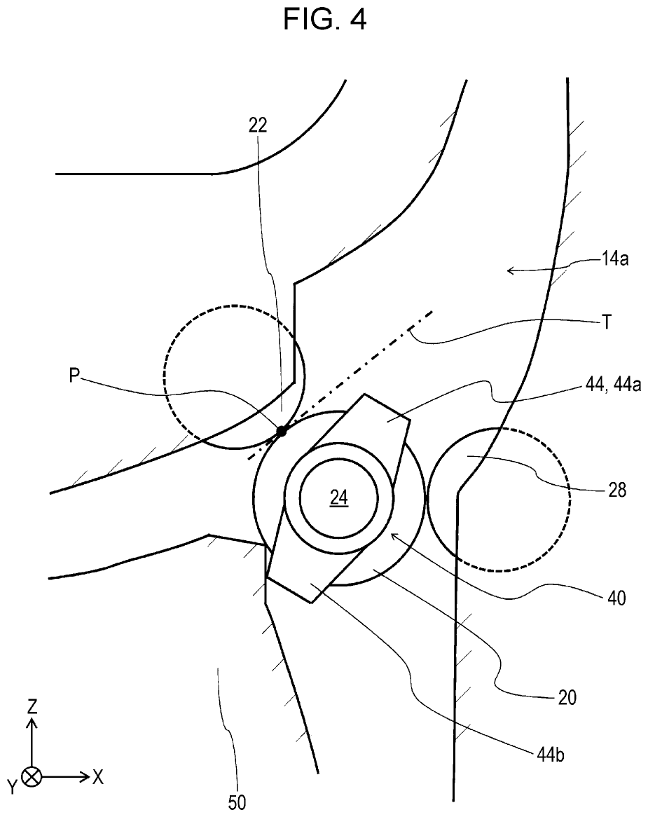

FIG. 4 is an enlarged side view of the driving roller 20 and the projecting member 40 attached to the shaft 24. As shown in FIG. 4, the outside diameter of the projecting member 40 at the position of the projections 44 is larger than the outside diameter of the driving roller 20. Hence, in a state in which the projecting member 40 is attached to the shaft 24, the projections 44a and 44b project radially outward further than the outer circumferential surface of the driving roller 20.

Although the projecting member 40 rotates with the shaft 24, which rotates clockwise in FIG. 4 in this exemplary embodiment, because the projection 44b projects radially outward further than the outer circumferential surface of the driving roller 20, the projection 44b comes into contact with a lower chute member 50, which is another member provided near the driving roller 20. As a result, the rotation of the projecting member 40 is restricted. In a state in which the projection 44b is in contact with the lower chute member 50, the projection 44a projects further toward the discharge path 14a than the outer circumferential surface of the driving roller 20.

As described above, although the projecting member 40 rotates with the shaft 24, because the projection 44b comes into contact with the lower chute member 50 and is inhibited from rotating, it is possible to position the projection 44a, which projects further toward the discharge path 14a than the outer circumferential surface of the driving roller 20, at a predetermined position.

Because the projection 44a projects further toward the discharge path 14a than the outer circumferential surface of the driving roller 20, drawing of a sheet into the duplex printing path 30 by the driving roller 20 and the duplex-path-side driven rollers 28 is suppressed, compared with a configuration without the projection 44a.

Even when a transported sheet is jammed as a result of being caught by an upper chute member, which defines the discharge path 14a, or being blocked by an object disposed at the discharge port, the trailing end of the sheet is caught by the projection 44a and is prevented from moving toward the nip portion between the driving roller 20 and the duplex-path-side driven roller 28. Hence, it is possible to suppress drawing of the sheet between the sheet driving roller 20 and the duplex-path-side driven roller 28.

The projection 44a projecting toward the discharge path 14a further than the outer circumferential surface of the driving roller 20 does not reach a tangent line T to the outer circumferential surface of the driving roller 20, the tangent line T passing through a nip P between the driving roller 20 and the discharge-side driven roller 22. In other words, the radial length and the angle of the projection 44a projecting toward the discharge path 14a are determined such that the projection 44a does not reach the tangent line T. When a sheet is guided into the discharge path 14a by the cooperation between the driving roller 20 and the discharge-side driven roller 22, the sheet is guided through the nip P along the tangent line T. If the projection 44a reaches the tangent line T, that is, if the projection 44a is located on the tangent line T, the projection 44a inhibits guiding of the sheet into the discharge path 14a. The projection 44a that does not reach the tangent line T suppresses drawing of the sheet into the duplex printing path 30 and enables smooth guiding of the sheet into the discharge path 14a.

The projecting member 40 attached to the shaft 24 has a point-symmetrical shape with respect to the shaft 24, as viewed in the axial direction of the shaft 24. In this exemplary embodiment, as described above, because the projecting member 40 has the projections 44a and 44b projecting in the opposite directions and having the same shape as viewed in the axial direction, the projecting member 40 has a point-symmetrical shape with respect to the shaft 24.

Hence, when the projecting member 40 is attached to the shaft 24, the shape of the projecting member 40 as viewed in the axial direction of the shaft 24 is the same regardless of in which direction the shaft 24 is inserted through the through-hole 42a. Because the shaft 24 can be inserted through the through-hole 42a in either direction, erroneous attachment of the projecting member 40 to the shaft 24 is prevented.

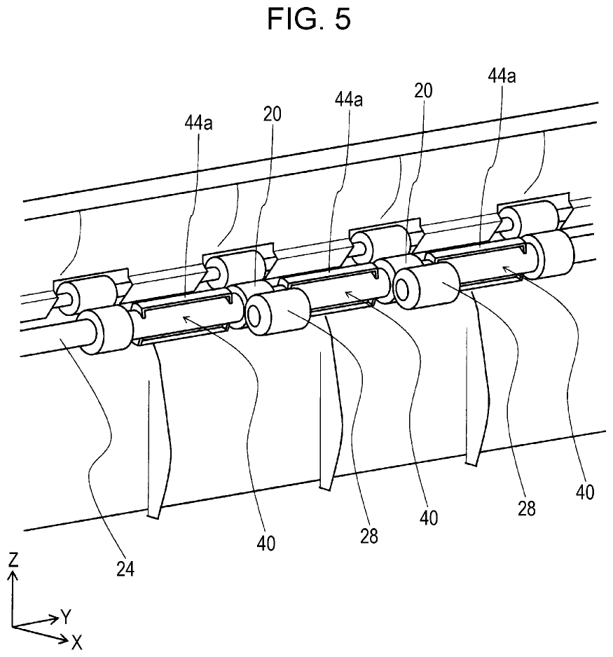

FIG. 5 is an enlarged perspective view of the driving rollers 20 and the projecting members 40 attached to the shaft 24, as viewed from the discharge path side. As shown in FIG. 5, in this exemplary embodiment, multiple projecting members 40 are attached to the shaft 24. Hence, multiple projections 44a, which project toward the discharge path 14a further than the outer circumferential surfaces of the driving rollers 20, are arranged side-by-side in the Y-axis direction.

The projecting members 40 are attached to the shaft 24 so as to have the driving rollers 20 therebetween. Hence, the projections 44a are provided on both sides of the driving rollers 20 in the Y-axis direction. More specifically, the projections 44a are provided on both sides, in the Y-axis direction, of the driving rollers 20 with which the duplex-path-side driven rollers 28 are externally in contact.

Drawing of a sheet into the duplex printing path 30 is caused by the sheet being drawn into the nip portions between the driving rollers 20 and the duplex-path-side driven rollers 28. Because the projections 44a are provided on both sides of the driving rollers 20, drawing of the sheet into the duplex printing path 30 is suppressed, compared with the configuration in which the projections 44a are provided only on one side of the driving rollers 20.

Although the exemplary embodiment of the present disclosure has been described above, the present disclosure is not limited to the above-described exemplary embodiment, and various modifications are possible within the scope not departing from the spirit of the present disclosure.

For example, in this exemplary embodiment, the projections 44 are provided on the projecting members 40, and the projecting members 40 are attached to the shaft 24. Hence, the projections 44 project toward the discharge path 14a further than the outer circumferential surfaces of the driving rollers 20. However, the projections 44 do not need to be provided on the projecting members 40 attached to the shaft 24 and may be provided on any member, as long as the projections 44 project toward the discharge path 14a further than the outer circumferential surfaces of the driving rollers 20. For example, it is possible to provide a member extending upward from below the shaft 24, the member being curved along the outer circumferential surface of the shaft 24 and extending upward until it projects further toward the discharge path 14a than the outer circumferential surfaces of the driving rollers 20. In this case, the upper end of this member serves as the projections 44. Also in this case, it is desirable that the projections 44 do not reach the tangent line T (see FIG. 4) and that the projections 44 be provided on both sides, in the Y-axis direction, of the driving rollers 20 with which the duplex-path-side driven rollers 28 are externally in contact.

The components of this exemplary embodiment do not necessarily have to be integrally molded and may be formed of multiple parts.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A recording-medium transport device comprising:
a driving roller that rotates in a driving manner;
a discharge-side driven roller that is externally in contact with the driving roller and guides a recording medium to a discharge path located downstream of the driving roller in cooperation with the driving roller;
a duplex-path-side driven roller that is externally in contact with the driving roller and guides, in cooperation with the driving roller, the recording medium from the discharge path to a duplex printing path; and
a projection that projects further toward the discharge path than an outer circumferential surface of the driving roller.

2. The recording-medium transport device according to claim 1, wherein the projection is provided on each side of the driving roller in a direction perpendicular to a recording-medium transport direction.

3. The recording-medium transport device according to claim 1, wherein the projection does not reach a tangent line to the outer circumferential surface of the driving roller, the tangent line passing through a nip between the driving roller and the discharge-side driven roller.

4. The recording-medium transport device according to claim 2, wherein the projection does not reach a tangent line to the outer circumferential surface of the driving roller, the tangent line passing through a nip between the driving roller and the discharge-side driven roller.

5. The recording-medium transport device according to claim 1, wherein
the driving roller and a projecting member having the projection are coaxially attached to a shaft that rotates in a driving manner, and
an outside diameter of the projecting member at a position of the projection is larger than an outside diameter of the driving roller.

6. The recording-medium transport device according to claim 2, wherein
the driving roller and a projecting member having the projection are coaxially attached to a shaft that rotates in a driving manner, and
an outside diameter of the projecting member at the position of the projection is larger than an outside diameter of the driving roller.

7. The recording-medium transport device according to claim 3, wherein
the driving roller and a projecting member having the projection are coaxially attached to a shaft that rotates in a driving manner, and
an outside diameter of the projecting member at the position of the projection is larger than an outside diameter of the driving roller.

8. The recording-medium transport device according to claim 4, wherein
the driving roller and a projecting member having the projection are coaxially attached to a shaft that rotates in a driving manner, and
an outside diameter of the projecting member at the position of the projection is larger than an outside diameter of the driving roller.

9. The recording-medium transport device according to claim 5, wherein the projecting member attached to the shaft has a point-symmetrical shape with respect to the shaft when viewed in an axial direction of the shaft.

10. The recording-medium transport device according to claim 6, wherein the projecting member attached to the shaft has a point-symmetrical shape with respect to the shaft when viewed in an axial direction of the shaft.

11. The recording-medium transport device according to claim 7, wherein the projecting member attached to the shaft has a point-symmetrical shape with respect to the shaft when viewed in an axial direction of the shaft.

12. The recording-medium transport device according to claim 8, wherein the projecting member attached to the shaft has a point-symmetrical shape with respect to the shaft when viewed in an axial direction of the shaft.

13. The recording-medium transport device according to claim 5, wherein the projecting member is inhibited from rotating by coming into contact with another member.

14. The recording-medium transport device according to claim 6, wherein the projecting member is inhibited from rotating by coming into contact with another member.

15. The recording-medium transport device according to claim 7, wherein the projecting member is inhibited from rotating by coming into contact with another member.

16. The recording-medium transport device according to claim 8, wherein the projecting member is inhibited from rotating by coming into contact with another member.

17. The recording-medium transport device according to claim 9, wherein the projecting member is inhibited from rotating by coming into contact with another member.

18. The recording-medium transport device according to claim 10, wherein the projecting member is inhibited from rotating by coming into contact with another member.

19. An image forming apparatus comprising:
an image forming part that forms an image on a recording medium;
a driving roller that rotates in a driving manner;
a discharge-side driven roller that is externally in contact with the driving roller and guides, in cooperation with the driving roller, the recording medium transported from the image forming part to the discharge path located downstream of the driving roller;
a duplex-path-side driven roller that is externally in contact with the driving roller and guides, in cooperation with the driving roller, the recording medium from the discharge path to a duplex printing path; and
a projection that projects further toward the discharge path than an outer circumferential surface of the driving roller.
